(19) United States
(12) Patent Application Publication
(10) Pub. No.: US 2018/0176262 A1
(43) Pub. Date: Jun. 21, 2018

(54) SYSTEMS AND METHODS FOR DEVICE SPECIFIC SECURITY POLICY CONTROL

(71) Applicant: University of North Texas, Denton, TX (US)

(72) Inventor: Krishna Kavi, Denton, TX (US)

(21) Appl. No.: 15/678,239

(22) Filed: Aug. 16, 2017

Related U.S. Application Data
(60) Provisional application No. 62/375,849, filed on Aug. 16, 2016.

(51) Int. Cl. H04L 29/06

(52) U.S. Cl. CPC H04L 63/205; H04L 67/12; H04L 63/0876

(57) ABSTRACT

A device specific security policy system and method is described. Certain embodiments provide for differentiated levels of authentication, security, monitoring, and/or protection for IoT devices using device and/or class specific security policies. Certain embodiments comprise identifying each of a plurality of devices, classifying each of the identified plurality of devices, invoking a security policy manager, wherein the security policy manager comprises a plurality of security policy containers, each of the plurality of security policy containers corresponding to one or more of the plurality of classified devices, wherein each of the plurality of security containers comprise a device specific security policy, and enforcing the device specific security policy for each of the plurality of classified devices.

### CROSS-REFERENCE TO RELATED APPLICATION

The present application claims the benefit of U.S. Provisional Patent Application No. 62/375,849, filed Aug. 16, 2016, the contents of which is incorporated herein by reference in its entirety.

### GOVERNMENT INTEREST

This invention was made with government support under Grant CNS 1361806, awarded by the National Science Foundation. The government has certain rights in the invention.

### TECHNICAL FIELD

The present disclosure relates generally to network security and, more particularly, to device specific security control.

### BACKGROUND

The “Internet of Things” (IoT) generally refers to a network of devices (e.g., vehicles, buildings, appliances, etc.) embedded with electronics, software, and sensors that enable the devices to collect and exchange data over a network, as well as operate in accordance with commands sent via the network. IoT is becoming increasingly widespread, with an estimated fifty billion devices to be connected by the year 2020. As IoT expands and as the number of IoT devices increases, so does the risk that IoT devices may be compromised. Thus, a matter of utmost importance is protecting the security of IoT devices.

Enforcing security policies in an IoT environment presents many challenges. Current IoT environments typically employ a one-size-fits-all approach to security, i.e., utilizing uniform security policies throughout the network, which results in a lack of flexibility and control. For example, an IoT environment may comprise devices communicating through a multitude of network protocols, each having a proprietary Maximum Transmission Unit (MTU) size. If a uniform security policy required all packets exceeding the size of 10 KB (for a specific type of device) to be dropped, the policy would not be able to protect other devices that communicate with larger MTU sizes.

As another example, a smart home with a network of IoT devices (e.g., appliances, thermostat, lights, fireplace, security system, garage door, locks, cameras, etc.) is considered. A hacker who defeats a uniform security policy protecting the devices may gain access to all of the devices within the system. For instance, a hacker may be able to innocuously turn lights on or off, or perhaps turn off the refrigerator and spoil food, or in a more extreme example, access a fireplace and potentially burn down the entire house. Current solutions generally employ an encrypted communication channel, firewall, and/or Intrusion Detection System (IDS) to protect a critical device such as a fireplace. A refrigerator, on the other hand, may not require the same level of security as a fireplace. However, with a uniform security policy system, a compromised refrigerator could lead to compromising the entire network, including a device such as a fireplace on the same network.

Existing solutions typically deploy a private cloud in a domestic environment to isolate the network in question, treating all devices uniformly without a device specific security policy control. Other solutions may provide network protocols to ensure that all IoT devices in a network using proprietary network protocols can communicate with one another but do not address the security implications of machine-to-machine (M2M) communication. As such, there is a need for an improved network security control system to ensure all types of devices in a network are appropriately protected.

### SUMMARY

The present application is directed to systems and methods that provide for differentiated levels of authentication, security, monitoring, and/or protection for IoT devices using device and/or class specific security policies. Certain embodiments include a method comprising identifying each of a plurality of devices, classifying each of the identified plurality of devices, invoking a security policy manager, wherein the security policy manager comprises a plurality of security policy containers, each of the plurality of security policy containers corresponding to a respective one of the plurality of classified devices, wherein each of the plurality of security containers comprise a device specific security policy, and enforcing the device specific security policy for each of the plurality of classified devices.

In another embodiment, a system for device specific security policy control comprises at least one processing device configured to identify each of a plurality of devices, classify each of the identified plurality of devices, invoke a security policy manager, wherein the security policy manager comprises a plurality of security policy containers, each of the plurality of security policy containers corresponding to one or more of the plurality of classified devices, wherein each of the plurality of security containers comprise a device specific security policy, and enforce the device specific security policy for each of the plurality of classified devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a device specific security policy control system in accordance with an embodiment of the present application;

FIG. 2 illustrates device specific security policy control system in accordance with an embodiment of the present application;

FIG. 3 illustrates exemplary DHCP identification information in accordance with an embodiment of the present application;

FIG. 4 illustrates a functional block diagram of an IoT framework architecture in accordance with an embodiment of the present application;

FIG. 5 illustrates a functional block diagram illustrating a race-free on-demand integrity measurement system in accordance with an embodiment of the present application; and

FIG. 6 illustrates a method for performing device specific security policy control in accordance with an embodiment of the present application.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

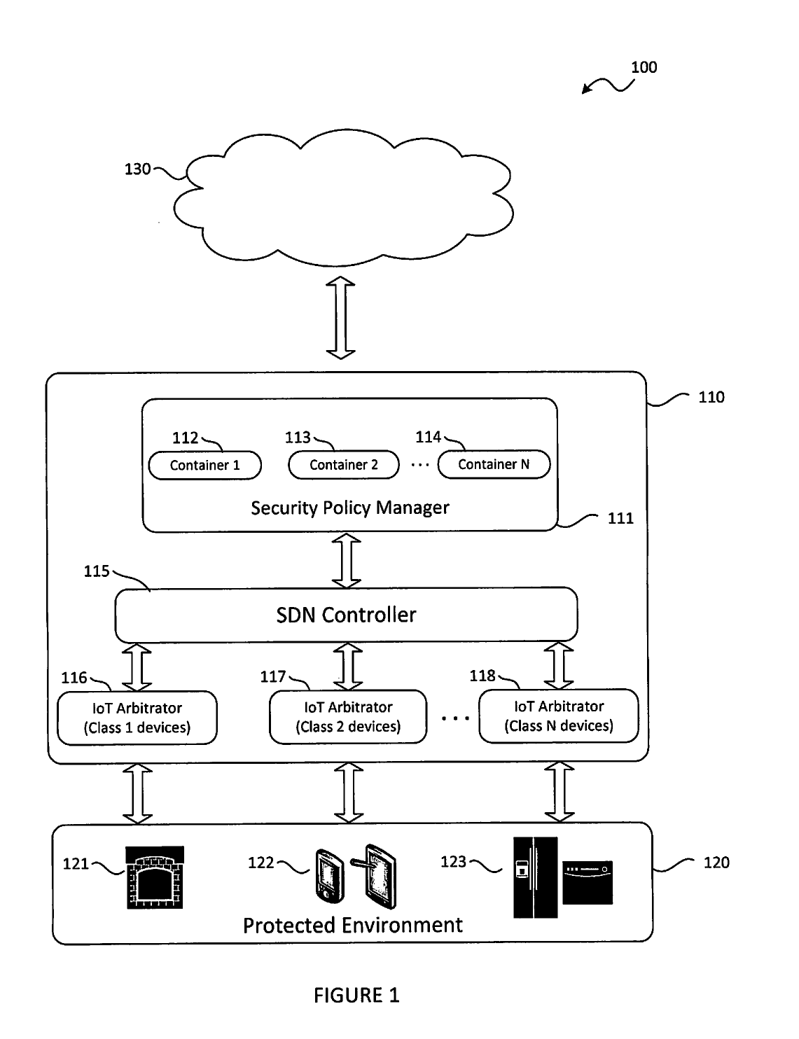

FIG. 1 illustrates an exemplary device specific security control system according to one embodiment of the application. The present application is discussed herein generally in the context of home networking, e.g., “smart homes,” wherein several appliances and devices may securely connect to and/or communicate with each other via machine-to-machine (M2M) and/or access to the internet. It should be appreciated that the embodiments disclosed herein are applicable to any number of systems where differentiated levels of security for devices is desirable. For instance, the embodiments described herein may have a multitude of other applications, including but not limited to, business applications and the like. Further, device specific security control system may be applicable to a number of other IoT environments, such as vehicles (e.g., connected cars and avionics), supply chain management, healthcare, manufacturing, etc.

FIG. 1 illustrates an embodiment of IoT system 100, wherein trusted environment 110 interfaces between protected environment 120 and untrusted external network 130. An exemplary untrusted external network 130 may include an untrusted network in which there is no indication regarding safety of the data, authenticity of communication devices, or the safety of the communication link itself. Untrusted external network 130 may be the source of an attack directed at devices within protected environment 120. As such, trusted environment 110 may serve to detect and handle a possible attack originating from untrusted external network 130. Further, as will be demonstrated, trusted environment 110 may protect devices within protected environment 120 from internal attacks. Trusted environment 110 may isolate protected environment 120 from untrusted external network 130 and enforce the integrity of devices within protected environment 120.

While the present disclosure assumes trusted environment 110 is separate from untrusted external network 130 and protected environment 120, it is appreciated that trusted environment 110 may be located on any number of devices, including any one of the devices located within protected environment 120. For instance, trusted environment 110 may be physically isolated from protected environment 120 on a separate physical device, or it may be located within protected environment 120. Further, trusted environment 110 may be located on any number of devices such as device 121, device 122, or device 123. In one embodiment, trusted environment 110 may be located on device 121 within protected environment 120. Other devices, e.g., device 122 and device 123, may communicate with trusted environment 110 in order to facilitate communication between other devices and between untrusted external network 130. In certain embodiments, devices may not include sophisticated computing capabilities, e.g., low power IoT devices, in which case trusted environment 120 may be separate from the device.

In certain embodiments, trusted environment 110 comprises security policy manager 111. Security policy manager 111 comprises a plurality of security function containers, each pertaining to a corresponding device or group of similar devices (e.g., TVs in a home). For example, if there are ten devices or groups of devices in protected environment 120, there would be ten corresponding security function containers. Each container may comprise a security policy pertaining to the security needs of the corresponding device. In certain embodiments, each security container may instead pertain to a corresponding group of devices sharing certain characteristics, as will be discussed further herein. FIG. 1 illustrates a security policy manager comprising container 112, container 113, and container 114. Container 112 may correspond to device 121, container 123 may correspond to device 122, and container 114 may correspond to device 123. Container 114, designated as “container N,” illustrates that there may be N containers in security policy manager 111. For instance, if there were one hundred devices, and therefore one hundred corresponding containers, container 114 would correspond with device 123, device 123 being the one hundredth device in the system. In an alternative embodiment, if the one hundred devices were grouped into ten separate groups with similar security policy needs, each of the ten groups may pertain to a corresponding one of ten containers. In that case, container 114 would be the tenth container corresponding to the tenth device group, i.e., device 123.

In certain embodiments, trusted environment 110 may also comprise a software-defined network (SDN) controller and a plurality of IoT arbitrators corresponding to each device in protected environment 120 to facilitate data transfer, monitoring, and the like. A SDN may isolate the network within trusted environment 110 such that different devices in protected environment 120 may use a different isolated network. This may serve to further enhance protection since traffic on one network may not interfere and/or compromise traffic on other networks. IoT arbitrators may serve as a communication hub between devices in protected environment 120 and SDN controller 115. SDN controller 115 may then facilitate communication between IoT arbitrators and security policy manager 111. In one embodiment, IoT arbitrator 116 corresponds to device 121, IoT arbitrator 117 corresponds to device 122, and IoT arbitrator 118 corresponds to device 123. In the alternative, the number of IoT arbitrators may correspond to the number of devices grouped according to certain characteristics. For instance, IoT arbitrator 116 may correspond to devices designated as “class 1 devices.” These may include high risk devices that could prove most harmful if compromised. In an exemplary home IoT network, class 1 devices may include devices such a fireplace. In this example, IoT arbitrator 116 would correspond with device 121. Device 121 may include other high risk devices such as a water heater, door locks, garage doors and the like, that if compromised, could allow someone to damage a house. Device 121 may comprise multiple devices with similar security needs, and correspond to IoT Arbitrator 116, or alternatively, each device may be ungrouped and each device pertaining to a different IoT arbitrator. Likewise, IoT arbitrator 117 may correspond to a group of “class 2 devices,” as designated by device 122, which may have less stringent security needs than device 121. For instance, device 122 may comprise a single smart phone, or perhaps a plurality of like devices, such as tablets, computers, and the like. Device 121 may then be considered a group of devices that correspond to device 117, or may, in another embodiment, pertain to only one device, each device corresponding to a separate IoT arbitrator. Further, IoT arbitrator 118 may correspond to a group of “class N devices,” N being the number of devices and/or groups of devices in protected environment 120. In one embodiment, IoT arbitrator 118 may correspond to device 123. Device 123 may include a refrigerator and other appliances, for instance. The security needs of device 123 may be less than that of device 122 and device 121.

It is appreciated that the present disclosure may be applicable to a number of other systems with varying types of devices. While the current discussion of certain embodiments illustrate systems and methods generally in the context of a home network of devices, device 121, device 122, device 123, and any other device or group of devices are not limited to same. For example, protected environment 120 may represent devices within a vehicle, a business setting, healthcare facility, and/or any other environment. A device may operate differently within different environments and have different security needs depending on a number of factors. As such, different IoT environments may utilize different trusted environments adapted to provide any needed security for that IoT environment. For example, device 122 (e.g., a smart phone) may be associated with container 113 within a home network ensuring an appropriate security policy is in place for device 122. In the same example, when device 122 moves, for instance, to a vehicle, device 122 would be in a new protected environment 120, and interact with trusted environment 110 pertaining to the vehicle. New security policies may be needed as device 122 may be able to access various systems and/or devices connected to the vehicle network (e.g., keyless entry, navigation, hands free, remote start, etc.). The methods and systems described herein may then be implemented in a similar manner. In one embodiment, the security needs of device 122 may increase when in a vehicle environment, and a more strict security policy may be determined to be appropriate for the setting. For example, the security policy of container 114 may be associated with device 122 in this new vehicle environment, indicating a different policy to be enforced with respect to device 122 within the vehicle environment.

In certain embodiments, devices may have differing constraints, e.g., limited processing power, footprint, size, power requirements, etc. In these embodiments, certain process may be offloaded to trusted environment 110. For instance, with certain IoT applications, devices may not have full operating systems, and/or have minimal functionality. In one embodiment, a device may be restricted and/or limited to what is needed by the device tailored to the applicable environment. For example, a refrigerator that needs access only to regulate temperature, notify a user that food has spoiled, or access the internet to order groceries may have limited processing power to access only these features. In this example, there may not be a need for a full operating system with full service security measures built in and trusted environment 110 may provide a device specific security function container and secure communication via IoT arbitrator and SDN controller to ensure a device specific policy is enforced and isolated from other device communication connections, while avoiding tying up resources of the device.

While some devices require a low level of security, (e.g., if such a device were to be compromised it would have minimal ramifications from a broad security view), other devices may require more nuanced security. For instance, it may be more prudent to have strict policies in effect for the protection of smart phones. A smart phone within a home network may have access to numerous appliances and other devices. A smart phone may be able to control a smart thermostat, fireplace, refrigerator, and unlock doors, etc. A hacker who compromises the smart phone may potentially gain access to these and other connected devices. This could lead to dire consequences, such as infiltrating the smart phone to gain access to a fireplace, and potentially burning down the house or disabling a security alarm to gain access through a networked garage door or door locks.

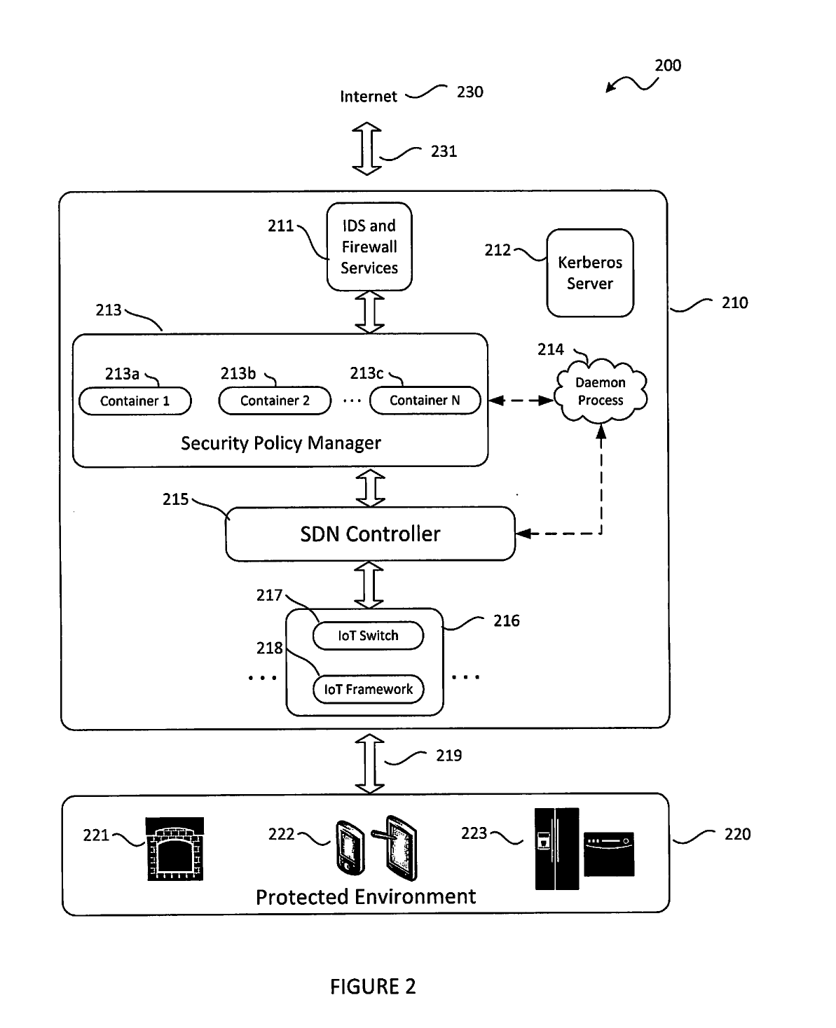

FIG. 2 illustrates an exemplary device specific security control system, IoT system 200, according to one embodiment of the application. Trusted environment 210 includes an intrusion detection system, such as IDS 211, which may operate as a first level of defense against potential attacks from Internet 230 at the point of connection 231 between trusted environment 210 and internet 230. IDS 211 may also comprise a firewall service for further first level defense. IDS 211 may also be used on demand to verify the integrity of software systems controlling specific devices or operating system functionalities of trusted environment 210. In order for trusted environment 210 to enforce device specific security policies for devices within protected environment 220, (e.g., device 221, device 222, and device 223), devices are first identified.

In certain embodiments, Dynamic Host Configuration Protocol (DHCP) fingerprinting may be used to identify devices. SDN controller 215 comprises a DHCP component that is operable to receive data from devices, including identification data. For instance, SDN controller 215 may receive identification data from device 221, device 222, device 223, and/or any other device in protected environment 220. Identification data is transmitted from the devices to trusted environment 210 via channel 219, where IoT arbitrator 216 receives and transmits the data to SDN controller. It is appreciated, as discussed above, that there may be any number of IoT arbitrators, each corresponding to a device (and/or device group) and a security function container. It is also appreciated that embodiments are not limited to a single communication channel. Each device may communicate via its own channel (e.g., a channel created by SDN controller 215 and/or a physical channel) to its corresponding IoT arbitrator located within trusted environment 210. Identification data may include DHCP packets containing varying identification data. The DHCP component of SDN controller 215 may then use the data received from the DHCP packets to identify each device. For instance, if a device has an operating system, the operating system may be identified by the DHCP fingerprinting process, and the device identified according to the operating system type, e.g., a laptop running Mac OS or Windows OS. It is appreciated that operating systems described herein may also include any system used to control the operation of a device. For instance, a device may have an operating system that lacks traditional operating system functionalities such as virtual memory management and/or task scheduling. In certain embodiments, devices having limited functionality and/or no operating system may be identified by other parameters such as device type. The received DHCP packets that are processed by the DHCP component of SDN controller 215 may contain various types of data that may be used to identify a device.

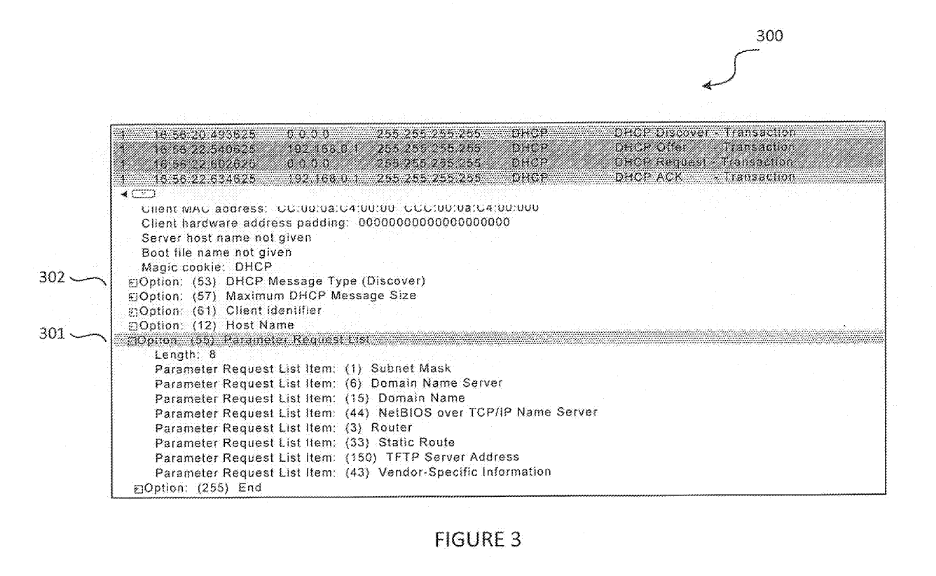

As illustrated by FIG. 3, DHCP list 300 comprises numerous parameters that may be contained in a DHCP packet from a device to be identified. For instance, Parameter Request List 301 illustrates parameters that may be used to identify a device. Parameter Request List 301 displays eight items: Subnet Mask, Domain Name Server, Domain Name, NetBIOS over TCP/IP Name Server, Router, Static Route, TFTP Server Address, Vendor-Specific Information. Additional parameters include items contained within DHCP Message Type 302. These parameters and other information contained in the DHCP packets may be extracted and used to identify a device. As discussed above, a device with an operating system may be identified based on the type of operating system on the device. Further, if a device lacked an operating system it may still be identified based on any number of parameters, such as vendor-specific information within Parameter Request List 301. Upon identifying each device, SDN controller 215 may then assign an Internet Protocol (IP) address to each identified device. For example, in FIG. 2, after identifying device 221, device 222, and device 223, based on the relevant DHCP fingerprint data associated with each device, each would be assigned a unique IP address. It is appreciated that the information included in FIG. 3 pertains to current implementations of DHCP and embodiments described herein are not limited to same. DHCP described herein may include additional implementations of DHCP including newer versions and the like.

Once a device is identified, the identified device may then be classified based on certain characteristics. Each identified device may be individually classified and a unique security policy applied to it. Policies may include, for example, access control rights, encryption requirements, and how integrity is verified. Classification of a device may be determined based on other pre-determined characteristics, e.g., security requirements of the device, device type, criticality of the device in an environment, and device capability. While devices may be individually classified based on certain characteristics, such as device 211 possibly pertaining only to a high risk fireplace, in another embodiment, devices may also be grouped into categories sharing similar characteristics. Any number of devices sharing similar security needs, for instance, could be grouped into the same category. If it is determined a single security policy would apply to a number of appliances, (e.g., a washer, dryer, and refrigerator), the appliances may be grouped into the same category. The group of appliances may then be categorized and a uniform security applied to the entire group. This group may be illustrated as device 223 in protected environment 220. In addition, certain communication devices, e.g., smart phones, tablets, computers, and the like, may be similarly grouped into another category, for instance, a category designated by device 222. By grouping multiple devices with similar characteristics together, it causes the system to operate in a more efficient manner. For example, in a hospital environment, a large number of patients wearing connected devices that capture health data may be identified as being similar devices having similar security requirements. In one embodiment, as the number of patients wearing the devices increases, the system may identify that it is more efficient to group the devices into a category, (e.g., “wearable devices”), and associate one security function container with one device specific (or in this case, category specific) security policy with the wearable devices category. Enforcing a single security policy over a large group of wearable devices may allow for increased speed of verification and monitoring of the wearable devices. In certain embodiments, devices may be unable to be identified, or may go unclassified on account of an appropriate security policy being unavailable. In these circumstances, SDN controller 215 may classify the unidentified devices into a default group with security policy manager 213 associating a security policy container with a default security policy.

As illustrated in FIG. 2, security policy manager 213 comprises security function containers 1-N (i.e., container-1, container-2, and container-N). The containers are illustrated as container 213a, container 213b, and container 213c. It is appreciated that containers may include a variety of machine virtualization, e.g., Virtual Machines (VMs), Guest VMs, containers, and the like. For instance, certain embodiments may implement Linux containers, the containers offering lower overhead by sharing certain portions of the host kernel and operating system of trusted environment 210. In one embodiment in which Linux containers are implemented, each container, e.g., container 213a, container 213b, and container 213c, may be configured with a snapshot of security policies. Each container is configured with a security policy corresponding to a device or and/or group of devices. Once a device is identified and classified, SDN controller 215 may invoke daemon process 214 that runs in the background. Daemon process 214 is configured such that it may invoke each one of the plurality of security function containers of security policy manager 213 that are either suspended or powered down. It is appreciated that the above description is illustrative of certain embodiments. One skilled in the art would understand that any other process that initiates an appropriate security policy in each container is possible in accordance with the disclosure herein.

In certain embodiments, a container, e.g., container 213a, container 213b, and/or container 213c, once invoked, may then be used to enforce the device/class specific policy with respect to the associated device/class in protected environment 220. For example, container 213a may be configured with a device specific security policy corresponding to device 221, and container 213b may be configured with a device class specific security policy for device 222 (e.g., a group of smart phones, tablets, and laptops). Daemon process 214 invokes the containers, which may have been in a powered down and/or lower energy consumption state. Once the containers are invoked, certain embodiments may use REST APIs, Kerberos servers, encryption mechanisms, and/or any application configured to implement security mechanisms, to enforce security policies for the identified and classified devices and/or groups of devices. In one embodiment, Kerberos server 212 is used to enforce the security policies for each respective device and/or class of devices. Kerberos server 212 may run in a container and authenticate token exchange between two communicating components of trusted environment 210. The specific security policies are downloaded onto SDN controller 215 and the respective security function container may return to a suspended or powered down state.

Enforcing security policies may include communicating a device specific security policy to the device, verifying the device complies with the security policy, and, in response to noncompliance, altering the device. It is appreciated that when reference is made to device, this may also include a group of devices. Altering the device may include denying service to the device, limiting service to the device, and the like. Enforcement may also include limiting access the device has to communicating with other devices, and/or isolating the device from the rest of the network. In certain embodiments, if a device is determined to not be in compliance with the assigned security policy, e.g., the device was hacked or the device was trying to operate outside of its rights according to the given security policy, communication to the device may be halted, or any other number of enforcement measures put in place. In other embodiments, the device may be quarantined and isolated from the other devices to prevent any further issues such as other devices potentially being compromised. For instance, the potentially compromised device may be assigned a new security policy in accordance with the discussion herein, albeit it may be a much stricter policy in order to monitor the device. In the event of one device being determined compromised, trusted environment 210 may also re-verify the status of all devices to mitigate any other potential damage.

While security policy manager 213 and corresponding security function containers may be configured into SDN controller 215, it is appreciated that the embodiment of FIG. 2 illustrates an example embodiment where the plurality of security containers and SDN controller 215 are isolated from each other. This isolated configuration minimizes exposure of the policies to make it more difficult for a hacker to access and/or compromise, thus ensuring the integrity of the policies to be enforced. For example, if a policy was compromised and reconfigured to allow a hacker to more easily gain access to a device, this would be undesirable. Policies configured on an SDN controller may make it easier to find an exploit in source code and gain access to the policies. Isolation of the components within trusted environment 210 may help prevent this issue. In addition, Kerberos server 212 may also encrypt the link of communication between security policy manager 213 and SDN controller 215, further ensuring the integrity of the policies to be enforced.

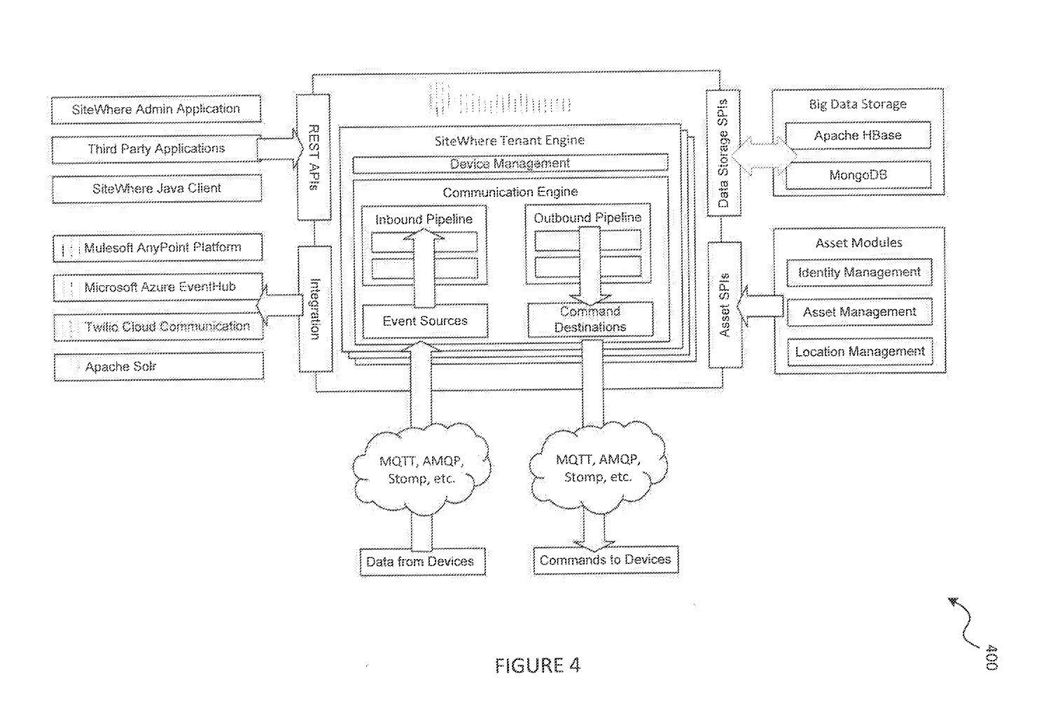

In certain embodiments, IoT arbitrator 216 (and any number of IoT arbitrators corresponding to the number of devices and/or device classes) may be used to facilitate communication between devices in protected environment 220 and trusted environment 210. IoT arbitrator 216 may reside in a Linux container. IoT arbitrator 216 may comprise IoT switch 217 and/or IoT framework 218. In some embodiments, IoT switch 217 is a virtual switch with which SDN controller 215 communicates. In embodiments where SDN controllers are unable to communicate directly with devices, IoT switch 217 provides communication between devices and trusted environment 210. In some embodiments, IoT arbitrator 216 may also include IoT framework 218. IoT framework 218 allows devices to communicate with each other. For example, certain low powered devices may be constrained in that the low powered devices may not be IP accessible. Therefore, IoT framework 218 may provide for M2M communication between these constrained devices and other devices. IoT arbitrator 216 may act as a communication broker between devices and trusted environment 210 by acting as a mediator between different types of IoT devices. FIG. 4 illustrates an embodiment of IoT framework 400. The exemplary IoT framework is “SiteWhere.” In an embodiment, IoT framework may be utilized in IoT Framework 218 as discussed above. SiteWhere may provide a mechanism to obtain, store, process, and migrate data among the devices of protected environment 220. Communication between devices and IoT framework may utilize message queue telemetry transport.

In certain embodiments, once the security policies for a specific device and/or class of devices are downloaded onto SDN controller 215, they are conveyed to their respective switch. In FIG. 2, IoT switch 217 is illustrated. However, it is appreciated each security policy corresponding to each device may be routed through its own separate IoT arbitrator, and thus IoT switch of the separate IoT arbitrator. SDN controller 215 maintains routing tables that provide an overview of the topology of IoT network 200. SDN controller contacts IoT switch that connects the device in question, appropriate flow table entries are made in IoT switch 216, and additional security policies are downloaded onto the switch. IoT switch 216 may utilize switches such as “Open vSwitch.” Further, in another embodiment, the security policies downloaded onto SDN controller 216 are deleted to prevent them from being compromised. IoT switch 216 uses this information to forward the packets accordingly. As discussed herein, each device and/or class of devices may be designated an IoT arbitrator. The container that hosts an IoT arbitrator is invoked when a device connects to trusted environment 210, and may return to a suspended state and/or power down state when no device is connected.

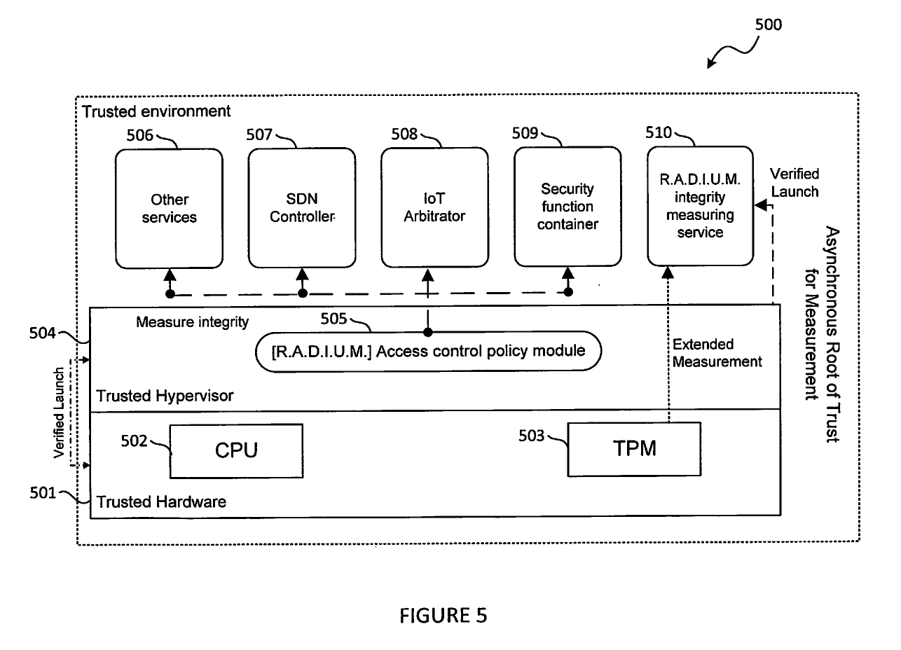

FIG. 5 illustrates a functional block diagram of a race-free on-demand integrity measurement system 500 in accordance with an embodiment of the present application. Race-free on-demand integrity measurement architecture (RADIUM) provides for on demand measurement of integrity and trustworthiness of components within the IoT system. For instance, RADIUM may isolate components, create virtual machines for critical devices that require more protection, and provide two layer authentication, e.g., requiring multiple layers of authentication before being able to take control of an IoT device. By way of another example, requiring increased levels of privacy for devices such as baby monitors, e.g., preventing the video feed from going outside a protected environment is possible. RADIUM allows for various virtual machines with unique policies for unique security needs.

In certain embodiments, on demand measurements may be independent of booting the system and launching the environment. That is, an application may be launched at any time and used at any time while ensuring trustworthiness through measurement at the time of using the application. System 500 includes trusted hardware 501, comprising CPU 502 and Trusted Platform Module (TPM) 503, trusted hypervisor 504, access control policy module (ACPM) 505, and at least one integrity measuring service 510. Root of trust for system 500 may be provided by Asynchronous Root of Trust for Measurement (ARTM). Integrity measuring service 510 is a trusted environment that measures other environments (e.g., target VM). The measuring service is measured, verified, and launched when other environments (VM) are to be measured. This service may be used as soon as it is launched and may be shut down as soon as it is done measuring. It is appreciated that integrity measurement may be performed without reliance on TPM 503 or other types of hardware level security enforcements. However, in certain embodiments, utilization of hardware security mechanisms may increase the trust in the integrity measurement.

In certain embodiments, hypervisor 504 runs at the highest privilege level, so a malicious and/or compromised hypervisor 504 could potentially give a hacker control over measuring service 510 and other environments running on the hypervisor (e.g., other services 506, SDN controller 507, IoT arbitrator 508, and security function container 509). To ensure the trustworthiness of hypervisor 504, it may be implemented using Dynamic Root of Trust for Measurement (DRTM). System 500 may allow access between its environments through ACPM 505. ACPM 505 comprises rules that identify the accessor environment and its corresponding accesses. ACPM 505 monitors all access between the environments and allows access to only devices that comply with the policy. Access requests that do not comply with the policy may be denied. In another embodiment, e.g., with a device that has lower security needs, a lack of compliance may be flagged but would not result in a complete denial of service.

In certain embodiments, a repository may maintain a patched and/or vulnerability free copy of each software that is used in the architecture. Embodiments may utilize repositories such as GitHub, SVN, and the like. Methods to measure integrity may include storing hash codes of the entire source code for each software in a container and/or other ways of assuring that the software was not modified or corrupted by malware and/or viruses. System 500 may be configured such that the hash code of the source code is computed at regular intervals and/or on demand. The computed hash code may then be compared against the stored hash code. Upon verification, integrity measuring service 510 may return to a suspended state, and/or is powered down. Integrity measuring service 510 may then be invoked again when a measurement is necessary. The integrity of the measuring service itself may be ensured by TPM 503 that is present along with the CPU 502. In one embodiment, all the containers that are invoked in the trusted environment of system 500 may run on a single hypervisor.

FIG. 6 illustrates a method 600 for performing device specific security policy control in accordance with an embodiment of the present application. It is noted that method 600 may be implemented within one or more systems, such as systems 100 and 200 described above. Method 600 may include identifying each of a plurality of devices at block 610. For example, identifying may include receiving data from each of the plurality of devices and assigning an IP address to each of the plurality of devices. Method 600 may also include classifying each of the identified plurality of devices at block 620. Classifying may further include determining a category for each of the identified plurality of devices and grouping each of the identified plurality of devices into a category. Method 600 may also include invoking a security policy manager, wherein the security policy manager comprises a plurality of security policy containers at block 630. In addition, each of the plurality of security policy containers may correspond to one or more of the plurality of classified devices, wherein each of the plurality of security containers comprise a device specific security policy at block 630. In another example, each of the plurality of security policy containers may correspond to a category of identified devices. Further, method 600 may include enforcing the device specific security policy for each of the plurality of classified devices at block 640.

It is noted that the functional blocks and modules in FIGS. 1-6 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for security control for a plurality of devices, the method comprising:
identifying, by at least one processor, each of the plurality of devices;
classifying, by the at least one processor, each of the identified plurality of devices;
invoking, by the at least one processor, a security policy manager, wherein the security policy manager comprises a plurality of security policy containers, each of the plurality of security policy containers corresponding to one or more of the plurality of classified devices, wherein each of the plurality of security containers comprise a device specific security policy; and
enforcing, by the at least one processor, the device specific security policy for each of the plurality of classified devices.

2. The method of claim 1 wherein identifying each of the plurality of devices further comprises receiving identification data from each of the plurality of devices.

3. The method of claim 2 wherein the received identification data includes a parameter request list.

4. The method of claim 3 wherein the parameter request list includes at least one of a subnet mask, domain name server, domain name, NetBIOS, Router, static route, TFTP server address, and vendor-specific information, DHCP information, subnet mask, domain name server, and domain name.

5. The method of claim 1 wherein classifying each of the identified plurality of devices further comprises:
determining, based on pre-determined characteristics, a category for each of the identified plurality of devices; and
grouping each of the identified plurality of devices into a corresponding determined category.

6. The method of claim 5 wherein the pre-determined characteristics include security requirements, device type, and device capability.

7. The method of claim 1 wherein each of the plurality of security policy containers are configured such that each of the plurality of security policy containers are invoked by a process and suspended when not invoked.

8. The method of claim 1 wherein the device specific security policy comprises at least one of access control rights and encryption requirements.

9. The method of claim 1 wherein enforcing the device specific security policy for each of the plurality of classified devices further comprises:
communicating the device specific security policy to the device;
verifying the device complies with the security policy; and
altering, in response to noncompliance, the device.

10. The method of claim 1 wherein enforcing the device specific security policy for each of the plurality of classified devices further comprises implementing an on demand integrity measurement.

11. The method of claim 1 wherein the plurality of devices are a plurality of internet of things devices.

12. A system for device specific security policy control comprising:
at least one processing device configured to:
identify each of a plurality of devices;
classify each of the identified plurality of devices;
invoke a security policy manager, wherein the security policy manager comprises a plurality of security policy containers, each of the plurality of security policy containers corresponding to one or more of the plurality of classified devices, wherein each of the plurality of security containers comprise a device specific security policy; and
enforce the device specific security policy for each of the plurality of classified devices.

13. The system of claim 13 wherein the at least one processing device is further configured to receive identification data from each of the plurality of devices.

14. The system of claim 14 wherein the received identification data includes a parameter request list.

15. The system of claim 15 wherein the parameter request list includes at least one of a subnet mask, domain name server, domain name, NetBIOS, Router, static route, TFTP server address, and vendor-specific information, DHCP information, subnet mask, domain name server, and domain name.

16. The system of claim 13 wherein the at least one processing device is further configured to:
determine, based on pre-determined characteristics, a category for each of the identified plurality of devices, wherein the pre-determined characteristics include security requirements, device type, and device capability; and
group each of the identified plurality of devices into a corresponding determined category.

17. The system of claim 13 wherein each of the plurality of security policy containers are configured such that each of the plurality of security policy containers are invoked by a daemon process and suspended when not invoked.

18. The system of claim 13 wherein the device specific security policy comprises at least one of access control rights and encryption requirements.

19. The system of claim 13 wherein the at least one processing device is further configured to:
communicate the device specific security policy to the device;
verify the device complies with the security policy; and
alter, in response to noncompliance, the device.

20. The system of claim 13 wherein enforcing the device specific security policy for each of the plurality of classified devices further comprises implementing an on demand integrity measurement.

21. The system of claim 13 wherein the plurality of devices are a plurality of internet of things devices.
